(19) United States
(12) Patent Application Publication
(10) Pub. No.: US 2009/0290129 A1
(43) Pub. Date: Nov. 26, 2009

(54) MOBILE TERMINAL DEVICE

(75) Inventor: Yohhei YOSHIDA, Osaka-shi (JP)

Correspondence Address: MORRISON & FOERSTER LLP, 1650 TYSONS BOULEVARD, SUITE 400, MCLEAN, VA, 22102, US

(73) Assignee: Sharp Kabushiki Kaisha, Osaka-shi (JP)

(21) Appl. No.: 12/465,314

(22) Filed: May 13, 2009

(30) Foreign Application Priority Data
May 26, 2008 (JP) 2008-137117

(51) Int. Cl. G03B 21/10; H04N 5/74; H04M 1/02; G03B 21/30

(52) U.S. Cl. 353/31; 348/744; 455/566; 348/E05.137; 353/71

(57) ABSTRACT

A mobile terminal device according to an embodiment of the present invention includes a mobile terminal device main body, a laser projector that projects a two-dimensional image by performing two-dimensional scanning of laser light emitted from a semiconductor laser, and a screen that serves as a main display screen that displays a two-dimensional image projected by the laser projector.

### CROSS-REFERENCE TO RELATED APPLICATIONS

This application claims priority under 35 U.S.C. § 119(a) on Patent Application No. 2008-137117 filed in Japan on May 26, 2008, the entire contents of which are herein incorporated by reference.

### BACKGROUND OF THE INVENTION

1. Field of the Invention

The present invention relates to a mobile terminal device provided with a laser projector that projects a two-dimensional image by performing two-dimensional scanning of laser light emitted from a semiconductor laser.

2. Description of the Related Art

In general, mobile terminal devices such as mobile telephones or the like include a liquid crystal display or an organic electroluminescent (EL) display, and can display various types of guides or data on their screens. However, the screen size of such a liquid crystal display or an organic EL display is set to a small size in accordance with the casing size of the mobile terminal device, and therefore it is sometimes difficult to visually recognize the content displayed on the screen.

JP 2001-21992A (hereinafter referred to as “Patent Document 1”) and JP 2002-261889A (hereinafter referred to as “Patent Document 2”) thus disclose mobile terminal devices that are provided with a small projector that is capable of projecting an enlarged image on an external screen, a wall, or the like.

However, because of the difficulty in projecting an enlarged image in the absence of an external screen, a wall, or the like, such mobile terminal devices as described in Patent Documents 1 and 2 use a liquid crystal display or an organic EL display in combination with the projector. However, providing both a projector and a display unit leads to an inevitable increase in cost, as well as increased power consumption despite being mobile equipment.

### SUMMARY OF THE INVENTION

The present invention was achieved in view of the above conventional problems, and it is an object thereof to provide a mobile terminal device that is capable of constantly displaying an image with only a projector and without requiring an external screen, a wall, or the like.

A mobile terminal device according to the present invention includes a mobile terminal device main body, a laser projector that projects a two-dimensional image by performing two-dimensional scanning of laser light emitted from a semiconductor laser, and a screen that serves as a main display screen that displays the two-dimensional image projected by the laser projector.

In such a mobile terminal device according to the present invention, the screen is provided to display a two dimensional image projected by the laser projector, which allows constant display of images without an external screen, a wall, or the like. Since the screen can serve as a main display screen and eliminates the necessity to use a display unit such as a liquid crystal display or an organic EL display as well, both the cost and power consumption can be reduced by omitting such a display unit.

Furthermore, in the mobile terminal device according to the present invention, the laser projector may include semiconductor lasers that emit respective laser light of a plurality of different wavelengths and may project a two-dimensional color image by performing two-dimensional scanning of the laser light emitted from the semiconductor lasers.

Furthermore, in the mobile terminal device according to the present invention, a portion near one end of the screen may be pivotally mounted to the mobile terminal device main body so that the screen is folded closed by pivoting the screen to overlie the mobile terminal device main body and is opened by pivoting the screen in the reverse direction.

In such a configuration, the screen is provided so that it can be pivoted and folded closed so as to overlie the mobile terminal device main body and can be opened by pivoting in the reverse direction. This makes it unnecessary to increase the size of the device.

Furthermore, in the mobile terminal device of the present invention, the screen may be provided with an opening so that when the screen is folded, a laser light outgoing portion of the laser projector is exposed through the opening in the screen.

In such a configuration, the laser light outgoing portion of the laser projector is exposed through the opening in the screen when the screen is folded closed; with the screen closed, laser light can be projected through the opening onto an external screen, a wall, or the like.

Furthermore, in the mobile terminal device according to the present invention, the laser projector may be rotatably supported by the mobile terminal device main body, and a laser light outgoing portion of the laser projector may be exposed by rotating the laser projector.

In such a configuration, since the laser projector is rotatably supported by the mobile terminal device main body and the laser light outgoing portion is exposed by rotating the laser projector, the size of the whole device can be reduced with ease.

Furthermore, the mobile terminal device according to the present invention may further include a cover that opens/closes a laser light outgoing portion of the laser projector.

In such a configuration, the cover is provided to open/close the laser light outgoing portion of the laser projector, which prevents unnecessary emission of laser light and keeps the laser light outgoing portion from being soiled.

Furthermore, in the mobile terminal device according to the present invention, the screen may be provided with a photodetector that detects the laser light emitted from the laser projector.

Furthermore, in the mobile terminal device according to the present invention, the photodetector may include a plurality of photodetectors provided in the screen.

Furthermore, in the mobile terminal device according to the present invention, each photodetector may be provided at one of the four corners of the screen.

Furthermore, the mobile terminal device according to the present invention may further include a determination means that determines, based on the timing of laser light detection by the photodetector, the state of laser light projection on the screen from the laser projector. In such a configuration, the state of laser light projection on the screen from the laser projector can be determined based on the timing of laser light detection performed by the photodetector.

Furthermore, the mobile terminal device according to the present invention may further include an image receiving means that receives an image signal through wired or wireless communications, and the laser projector may project, on the screen, an image that is represented by the image signal received by the image receiving means. For example, an image received from a TV broadcast may be projected on the screen.

Furthermore, the mobile terminal device according to the present invention may further include a telephone communications means that makes a telephone call through wired or wireless communications.

Such a configuration allows telephone calls through wired or wireless communications. Thus, the mobile terminal device according to the present invention can be used as a mobile telephone.

### BRIEF DESCRIPTION OF THE DRAWINGS

FIG. 1A is an oblique view of a mobile telephone, with its screen panel open, that is a first embodiment of a mobile terminal device according to the present invention.

FIG. 1B is an oblique view of the mobile telephone in FIG. 1A with its screen panel closed.

FIG. 2A is a side view of the mobile telephone in FIG. 1A with its screen panel open.

FIG. 2B is a side view of the mobile telephone in FIG. 1A with its screen panel closed.

FIG. 3 is a block diagram illustrating a configuration of the mobile telephone in FIG. 1A.

FIG. 4 is an oblique view illustrating a general configuration of a laser projector in the mobile telephone in FIG. 1A.

FIG. 5 illustrates the state of detection of laser light at photodiodes that are provided at four corners on a screen panel in the mobile telephone in FIG. 1A.

FIG. 6A is an oblique view of the mobile telephone in FIG. 1A when projecting an image with its screen panel closed.

FIG. 6B is a side view of the mobile telephone in FIG. 1A when projecting an image with its screen panel closed.

FIG. 7A is an oblique view of another example of the mobile telephone in FIG. 1A.

FIG. 7B is a side view of the mobile telephone in FIG. 7A.

FIG. 8 is an oblique view of the mobile telephone in FIG. 7A with its cover open.

FIG. 9 is an oblique view illustrating a general configuration of a color laser projector.

FIG. 10A is an oblique view of a mobile telephone, with its screen, panel open, that is a second embodiment of a mobile terminal device according to the present invention.

FIG. 10B illustrates the mobile telephone in FIG. 10A with its screen panel closed.

FIG. 11A is an oblique view of a laser projector in the mobile telephone in FIG. 10A.

FIG. 11B is a perspective view of the laser projector in the mobile telephone in FIG. 10A.

FIG. 12 is an oblique view of the mobile telephone in FIG. 10A with the casing of a laser projector rotated 90 degrees.

FIG. 13 is an oblique view of a mobile telephone that is a third embodiment of the mobile terminal device according to the present invention.

FIG. 14A is an oblique view of the mobile telephone in FIG. 13 with a screen panel of a laser projector open.

FIG. 14B is an oblique view of the mobile telephone in FIG. 13 with the screen panel of the laser projector closed.

FIG. 15 is an oblique view of another example of the mobile telephone in FIG. 13.

### DESCRIPTION OF THE PREFERRED EMBODIMENTS

Hereinafter, embodiments of the present invention will be described with reference to the attached drawings.

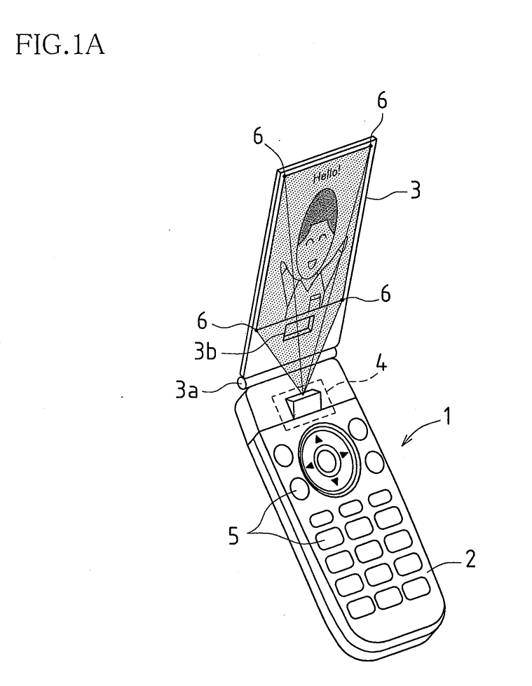

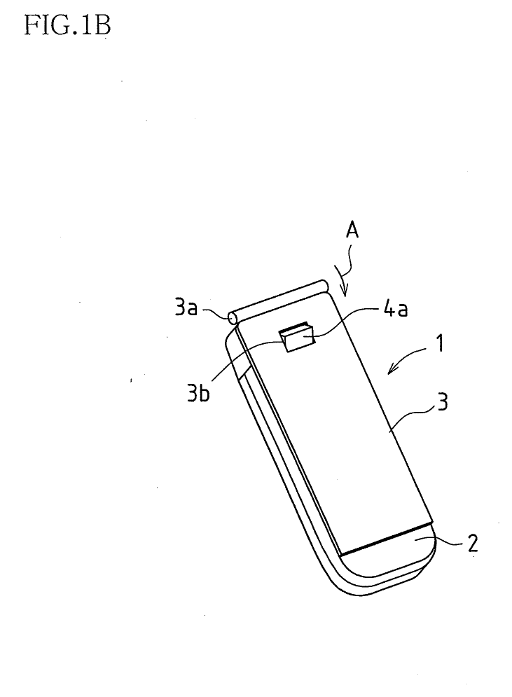

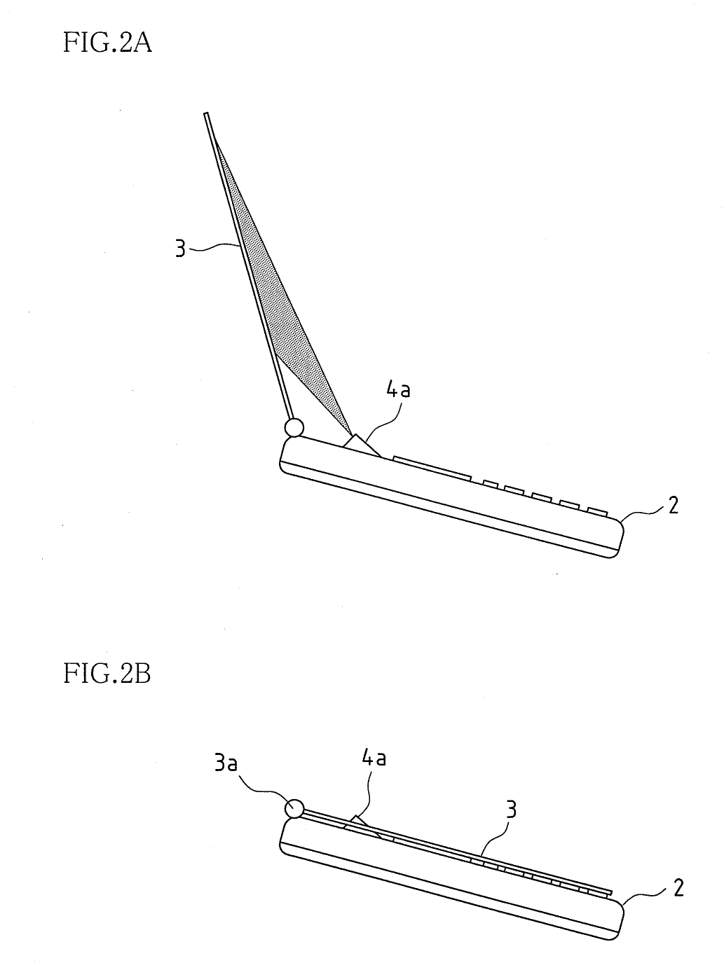

FIGS. 1A and 1B are oblique views of a mobile telephone that is a first embodiment of a mobile terminal device according to the present invention. FIGS. 2A and 2B are side views of the mobile telephone according to the first embodiment.

A mobile telephone 1 according to the present embodiment includes a main casing (mobile terminal device main body) 2, a screen panel (screen) 3 that is pivotally mounted on the main casing 2 so as to be freely openable and closable, and a laser projector 4 that partially extends from the upper surface of the main casing 2.

The main casing 2 has various kinds of operation keys 5 disposed on its upper surface. The screen panel 3 is pivotally supported on one end of the main casing 2 by a shaft 3a that extends along one side of the screen panel 3. The screen panel 3 is folded closed by pivoting the screen panel 3 in the direction of the arrow A so as to overlie the main casing 2 as illustrated in FIGS. 1B and 2B, and is opened by pivoting the screen panel 3 in the reverse direction as illustrated in FIGS. 1A and 2A. An opening 3b is formed in the screen panel 3, so that when the screen panel 3 is folded as illustrated in FIGS. 1B and 2B, an extended part 4a of the laser projector 4 is exposed through the opening 3b on the upper side of the screen panel 3. The screen panel 3 is further provided with a photodiode 6 at each of its four corners.

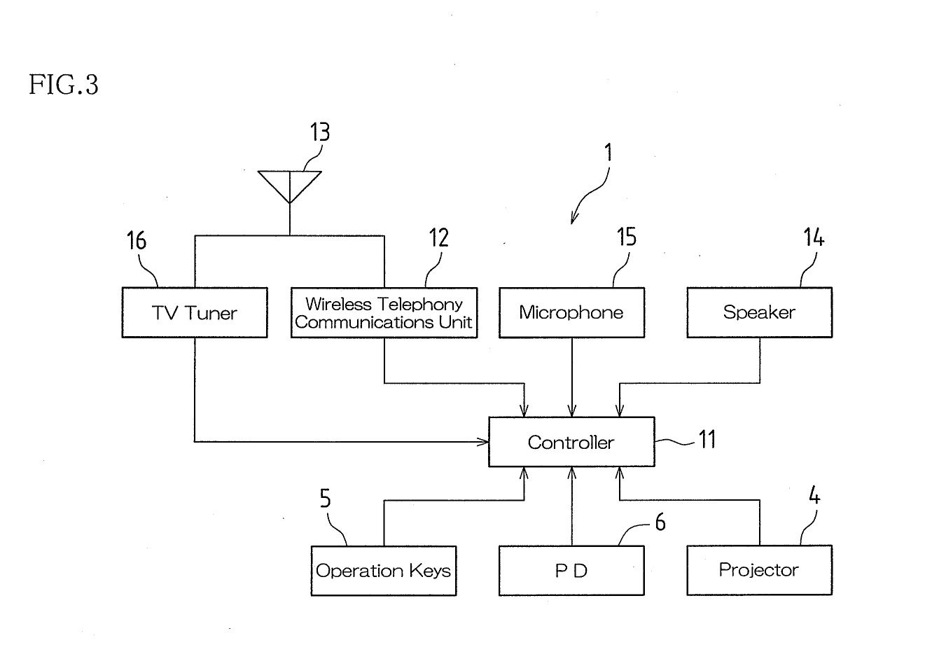

FIG. 3 is a block diagram illustrating a general configuration of the mobile telephone 1. As illustrated in FIG. 3, a controller 11 is configured to control the entire mobile telephone 1, and controls a wireless telephony communications unit 12 in response to input instructions resulting from operation of the operation keys 5, outputs image signals to the laser projector 4, and so on. The controller 11 also receives outputs of received light from the photodiodes 6 that are provided at the four corners of the screen panel 3 and, based on those received-light outputs, determines the degree to which the screen panel 3 is opened/closed.

The wireless telephony communications unit 12 is configured to carry out wireless telephony communications through an antenna 13, and executes a prescribed communications protocol or the like to either originate a call or answer an incoming call, receives audio signals and applies those audio signals to a speaker 14, and transmits audio signals received from a microphone 15.

A TV tuner 16 receives and demodulates broadcasting signals broadcast through digital terrestrial broadcasting and the like through the antenna 13, and outputs resultant image signals to the laser projector 4 via the controller 11.

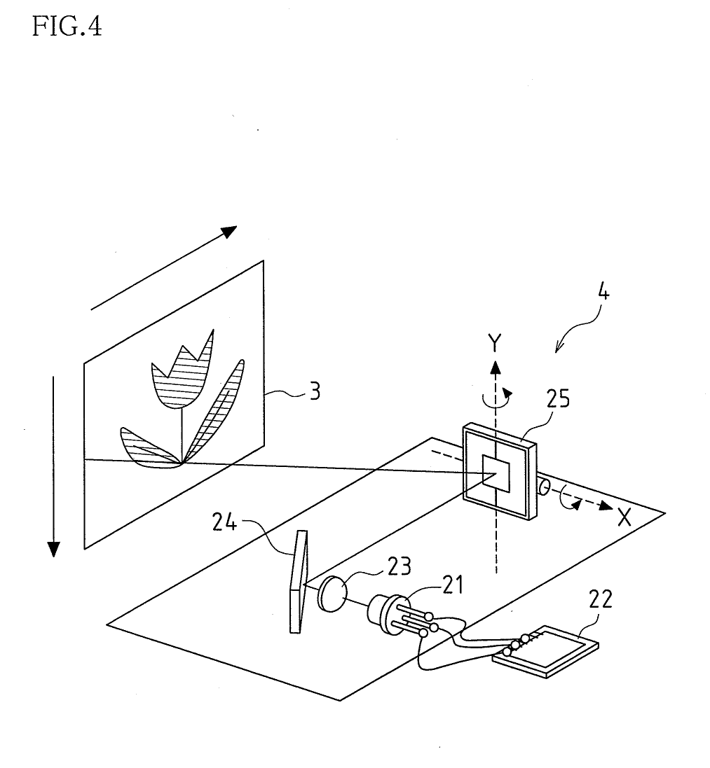

FIG. 4 is an oblique view illustrating a general configuration of the laser projector 4. This laser projector 4 includes a semiconductor laser 21 that emits laser light, a driving circuit 22 for the semiconductor laser 21, a collimating lens 23 that converts the laser light emitted from the semiconductor laser 21 into collimated light, a mirror 24 that reflects laser light to change the direction of the light, and a two-dimensional mirror scanner 25 that reflects laser light and performs two-dimensional scanning of the light in both the main- and sub-scanning directions.

The two-dimensional mirror scanner 25 is a MEMS (Micro Electro Mechanical Systems) device and includes a mirror that reflects laser light and an actuator that rotates the mirror around both the X and Y axes at high speed and with high accuracy so as to scan the laser light in two dimensions.

As illustrated in FIGS. 1A and 2A, the laser light that is scanned in two dimensions by the two-dimensional mirror scanner 25 is projected from the extended part 4a of the laser projector 4 on the screen panel 3, whereby an image is projected on the screen panel 3.

The controller 11 generates image signals that represent an image such as a guide or the like on the mobile telephone 1 and outputs such image signals to the laser projector 4, outputs image signals that are received from the TV tuner 16 to the laser projector 4, and so on. The laser projector 4 receives image signals from the controller 11 and projects an image (e.g., an image such as a guide or the like or an image from TV broadcasting) that is represented by the image signals on the screen panel 3.

In such projection, the two-dimensional mirror scanner 25 performs two-dimensional scanning in such a manner that the range of projection of laser light fits exactly on the screen panel 3 as illustrated in FIGS. 1A and 2A.

The controller 11 detects, based on outputs of received light of the photodiodes 6 that are provided at the upper two corners of the screen panel 3, the timings of laser light detection at those photodiodes 6 and determines whether or not those timings coincide with scanning start and end timings for a single main scanning line. Similarly, the controller 11 detects, based on outputs of received light of the photodiodes 6 that are provided at the lower two corners of the screen panel 3, the timing of laser light detection at those photodiodes 6 and determines whether or not those timings coincide with scanning start and end timings for a single main scanning line.

Then, the controller 11 controls the scanning angle at which the two-dimensional mirror scanner 25 performs scans in the main scanning direction, so that the timings of laser light detection at the photodiodes 6 that are provided at the upper two corners coincide with the scanning start and end timings for an upper main scanning line L1, and the timings of laser light detection at the photodiodes 6 that are provided at the lower two corners coincide with the scanning start and end timings for a lower main scanning line L2.

Since the distance from the screen panel 3 to the two-dimensional mirror scanner 25 is long on the upper side of the screen panel 3 and then decreases gradually toward the lower side of the screen panel 3, the scanning angle at which the two-dimensional mirror scanner 25 performs scans in the main scanning direction is gradually reduced as the scanning progresses from upper to lower main scanning lines. This allows the main scanning lines on the screen panel 3 to have a constant length.

Thus, the controller 11 controls the scanning angle at which the two-dimensional mirror scanner 25 performs scans in the main scanning direction, in such a manner that the scanning angle is reduced as the scanning progresses from upper to lower main scanning lines so that the main scanning lines on the screen panel 3 have a constant length.

With such control, the range of projection of the laser light fits exactly on the screen panel 3.

Alternatively, the controller 11 may prompt the user, through a display on the screen panel 3, to control an opening angle α of the screen panel 3 so that the opening angle α of the screen panel 3 relative to the main casing 2 is adjusted to a set angle so that the range of projection of laser light fits exactly on the screen panel 3.

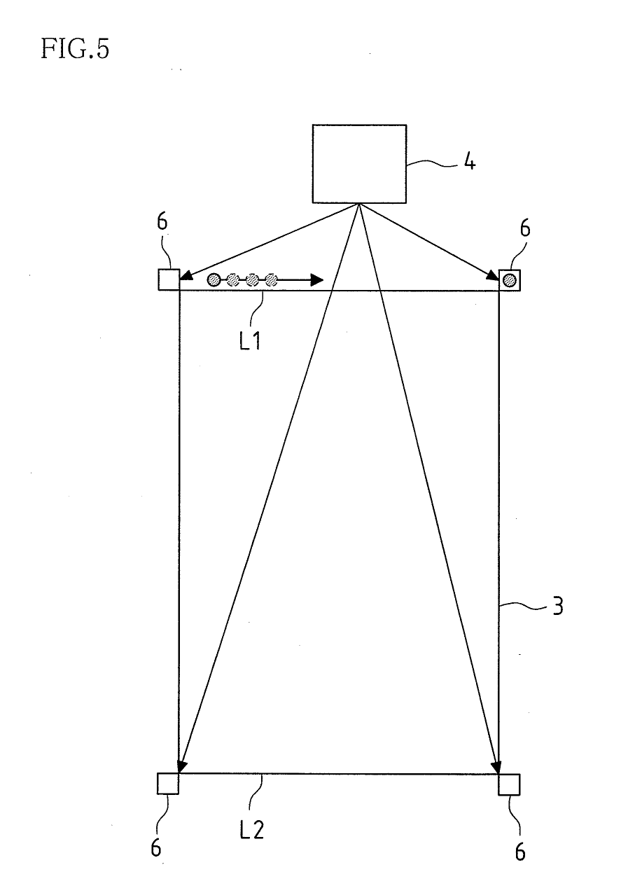

When the opening angle α of the screen panel 3 relative to the main casing 2 is adjusted to the set angle and the range of projection of laser light can fit exactly on the screen panel 3, as illustrated in FIG. 5, the photodiodes 6 that are provided at the upper two corners of the screen panel 3 will receive laser light concurrently with the scanning start and end timings for the upper main scanning line L1, and the photodiodes 6 that are provided at the lower two corners of the screen panel 3 will receive laser light concurrently with the scanning start and end timings for the lower main scanning line L2. At this time, since the timings of laser light detection by the photodiodes 6 provided at the upper two corners coincide with the scanning start and end timings for the upper main scanning line L1 and the timings of laser light detection by the photodiodes provided at lower two corners coincide with the scanning start and end timings for the lower main scanning line L2, the controller 11 determines that the opening angle α of the screen panel 3 is the set angle and displays as such on the screen panel 3 through the laser projector 4. The user can understand from such a display that the opening angle α of the screen panel 3 is appropriate.

When the opening angle α of the screen panel 3 exceeds the set angle, the distance between the screen panel 3 and the two-dimensional mirror scanner 25 becomes long, in which case the range of projection of laser light lies off the edge of the screen panel 3, and the timings of laser light detection by the photodiodes 6 provided at the upper two corners of the screen panel 3 do not coincide with the scanning start and end timings for the upper main scanning line L1 and the timings of laser light detection by the photodiodes 6 provided at the lower two corners do not coincide with the scanning start and end timings for the lower main scanning line L2. At this time, the controller 11 determines, based on such a difference in the timings of laser light detection, that the opening angle α of the screen panel 3 exceeds the set angle and displays as such on the screen panel 3 through the laser projector 4. The user can thus adjust, based on such display, the opening angle α of the screen panel 3 to a smaller angle.

Moreover, when the opening angle α of the screen panel 3 is less than the set angle, the distance between the screen panel 3 and the two-dimensional mirror scanner 25 becomes short, in which case the range of projection of laser light is smaller than the screen panel 3, and the photodiodes 6 provided at the upper two corners of the screen panel 3 receive no light for the duration of the scanning of the upper main scanning line L1, and the photodiodes 6 provided at the lower two corners also receive no light for the duration of the scanning of the lower main scanning line L2. At this time, since each photodiode 6 receives no light for the duration of the scanning of a single main scanning line, the controller 11 determines that the opening angle α of the screen panel 3 is less than the set angle and displays as such on the screen panel 3 through the laser projector 4. The user can thus adjust, based on such display, the opening angle α of the screen panel 3 to a greater angle.

Therefore, the user can adjust the opening angle α of the screen panel 3 to the set angle while checking the degree of the opening angle α of the screen panel displayed on the screen panel 3.

Note that even if a photodiode 6 is provided only at one corner of the screen panel 3, the degree (large or small) of the opening angle α of the screen panel 3 can be determined based on the timing of laser light detection by that photodiode 6. Or, a photodiode 6 may be provided in any position as long as it is a position where the timing of laser light detection varies depending on the degree of the opening angle α of the screen panel 3, and the degree of the opening angle α can be determined based on the timing of laser light detection by that photodiode 6.

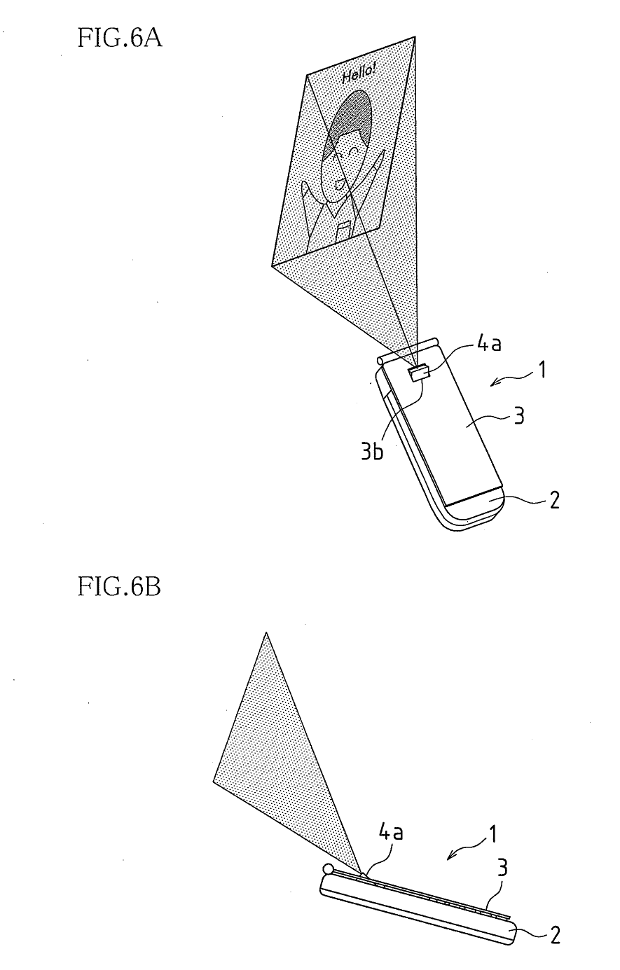

On the other hand, when, as illustrated in FIGS. 6A and 6B, the screen panel 3 is folded and the extended part 4a of the laser projector 4 is exposed through the opening 3b on the upper side of the screen panel 3, an enlarged image can be projected by the laser projector 4 projecting laser light through the opening 3b onto an external screen, a wall, or the like.

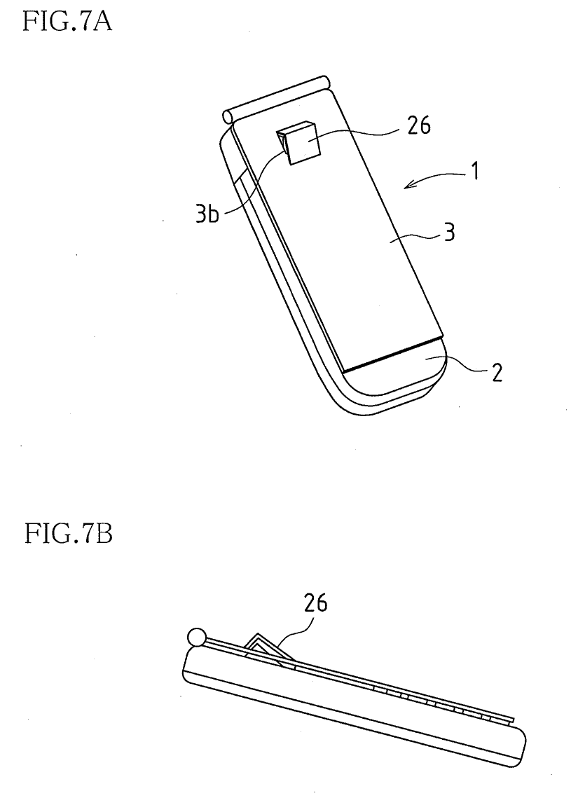

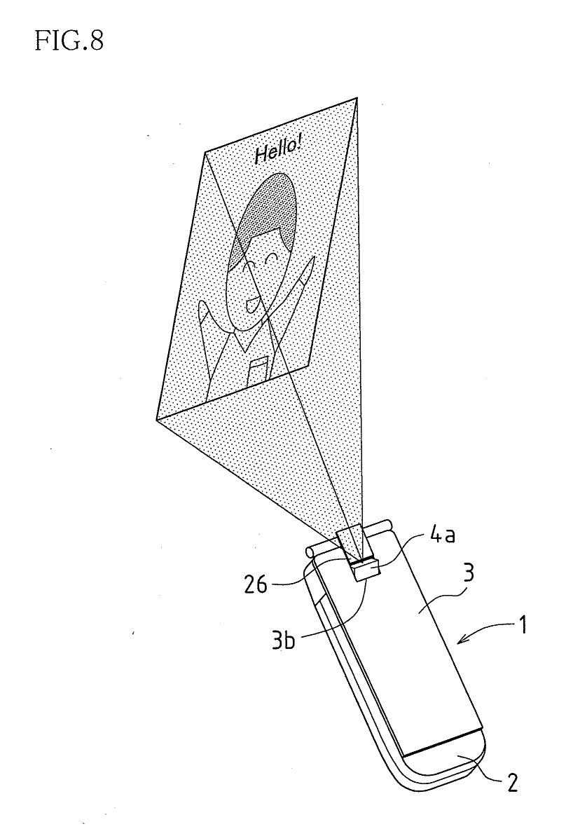

In the mobile telephone 1 with such a configuration, as illustrated in FIGS. 7A and 7B, the opening 3b of the screen panel 3 may be provided with a cover 26 that opens/closes a laser light outgoing portion of the extended part 4a of the laser projector 4. This cover 26 is a V-shaped piece having one of its sides pivotally mounted at one edge of the opening 3b so as to be freely openable and closable. When the screen panel 3 is folded and the cover 26 is closed, unnecessary emission of laser light can be prevented, and the laser light outgoing portion can be kept from being soiled. When the cover 26 is open as illustrated in FIG. 8, the laser projector 4 can project laser light so as to project an enlarged image on an external screen, a wall, or the like.

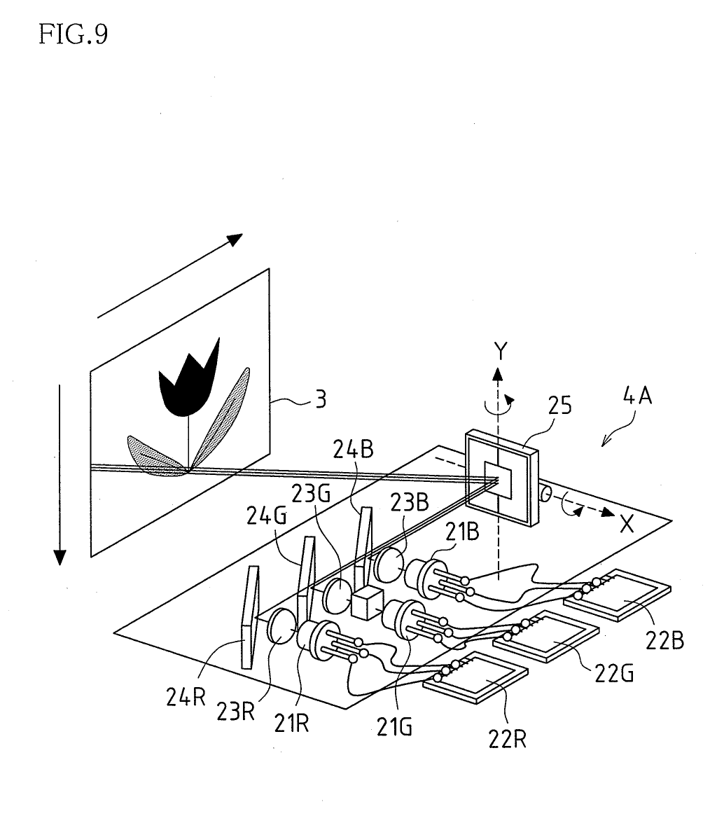

The laser projector 4 in FIG. 4 is configured to project a monochrome image; instead of this, a laser projector 4A as illustrated in FIG. 9 that is capable of projecting a color image may be used. This color laser projector 4A includes semiconductor lasers 21R, 21G, and 21B that emit laser light of different wavelengths, or red, green, and blue, respectively; driving circuits 22R, 22G, and 22B for the semiconductor lasers 21R, 21G, and 21B respectively; collimating lenses 23R, 23G, and 23B that convert laser light of each color into collimated light; a mirror 24R that reflects the laser light emitted from the semiconductor laser 21R; a half-mirror 24G that reflects the laser light emitted from the semiconductor laser 21G and passes the laser light reflected in the mirror 24R; a half-mirror 24B that reflects the laser light emitted from the semiconductor laser 21B and passes the laser light reflected in the mirror 24R and the half-mirror 24G; and the two-dimensional mirror scanner 25 that reflects laser light of each color and performs two-dimensional scanning of the laser light in both the main- and sub-scanning directions. With the mirrors 24R, 24G, and 24B, the laser light of each color is superimposed on the same optical axis and enters a mirror of the two-dimensional mirror scanner 25, in which the laser light of each color is then scanned in two dimensions and projected onto the screen panel 3, whereby a color image is projected on the screen panel 3.

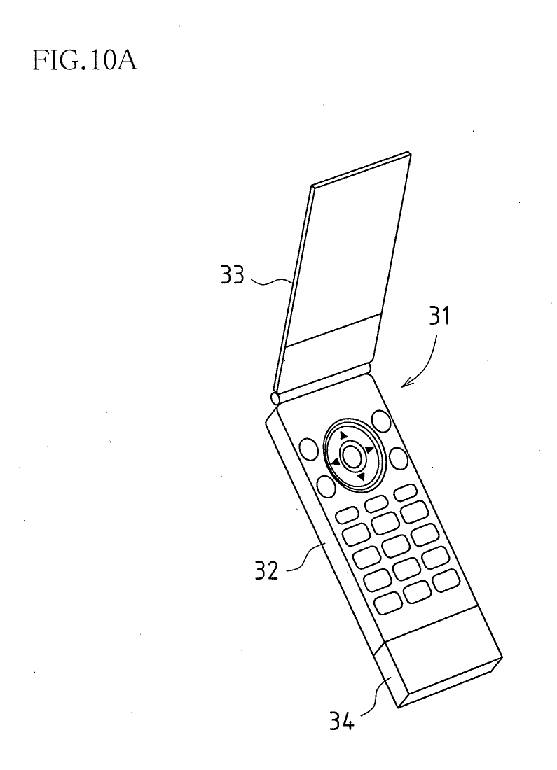

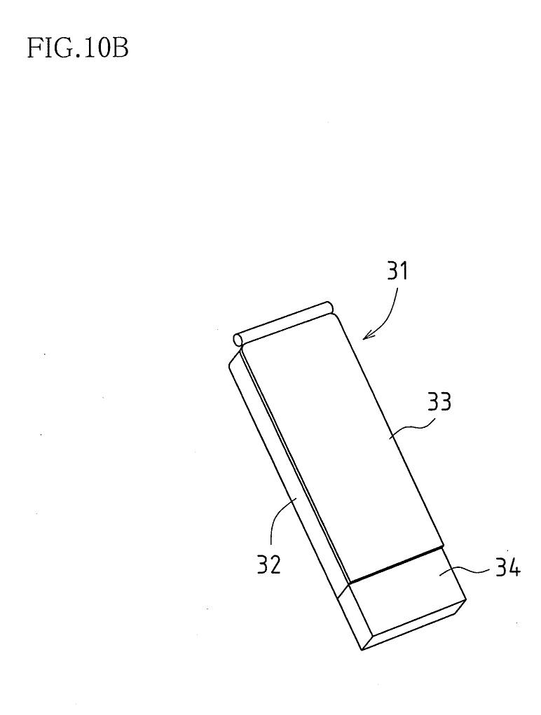

FIGS. 10A and 10B are oblique views of a mobile telephone that is a second embodiment of the mobile terminal device according to the present invention.

A mobile telephone 31 according to the present embodiment includes a main casing (mobile terminal device main body) 32, a screen panel (screen) 33 that is pivotally mounted to the main casing 32 so as to be freely openable and closable, and a laser projector 34 that is provided at the lower end of the main casing 32.

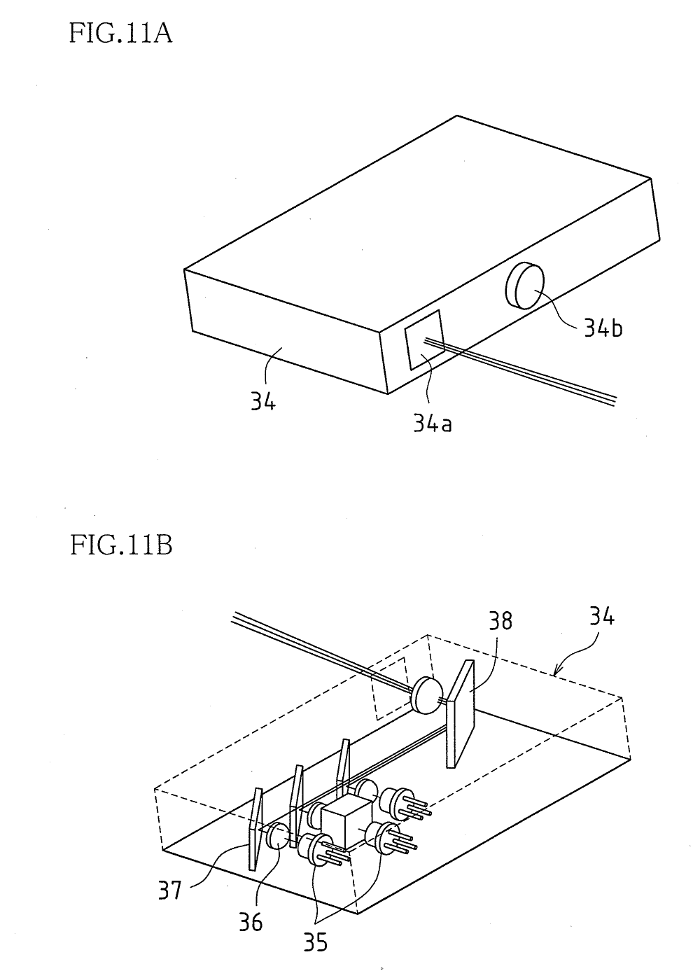

The laser projector 34 is a case-like device that has the same width and thickness as the main casing 32. It has, as illustrated in FIG. 11A, a laser light outgoing portion 34a and a rotating shaft 34b on one of its end faces; the rotating shaft 34b is rotatably supported on the side of the main casing 32 so that the laser projector 34 is rotatable relative to the main casing 32. As illustrated in FIG. 11B, the laser projector 34 is, like the laser projector 4A in FIG. 9, a color laser projector and includes three semiconductor lasers 35, three collimating lenses 36, three mirrors or half-mirrors 37, a two-dimensional mirror scanner 38, and so on.

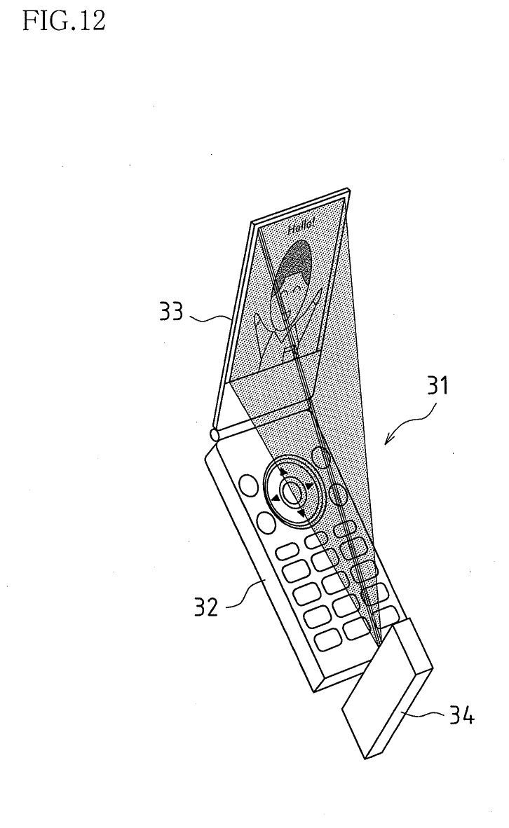

When, as illustrated in FIG. 12, the screen panel 33 is opened and the laser projector 34 is rotated 90 degrees relative to the main casing 32, the laser light outgoing portion 34a of the laser projector 34 is exposed facing the screen panel 33, which allows the laser projector 34 to project laser light from its laser light outgoing portion 34a on the screen panel 33 to thereby project an image on the screen panel 33.

In particular, when the laser projector 34 is large in size, the provision of the laser projector 34 at one end of the main casing 32, as in the present embodiment, makes the whole mobile telephone 31 more compact.

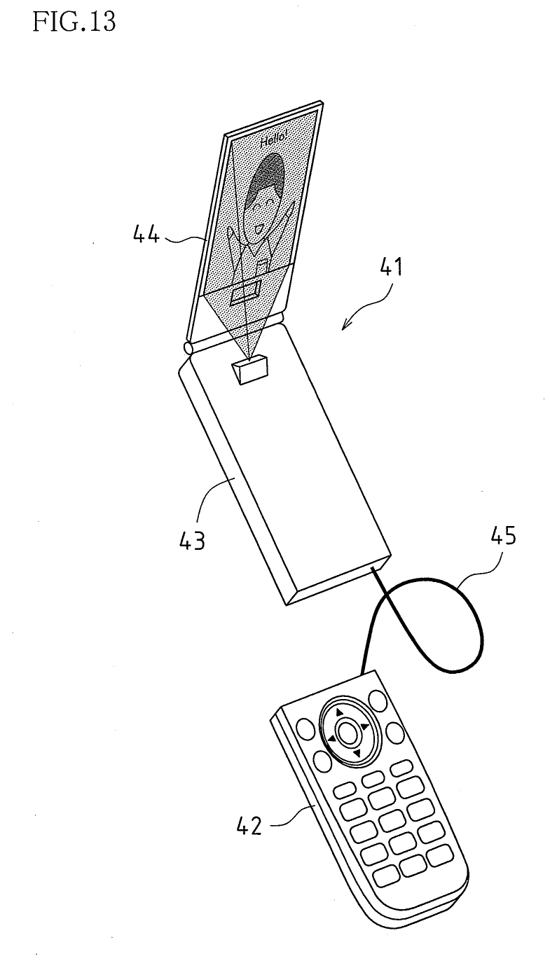

FIG. 13 is an oblique view of a mobile telephone that is a third embodiment of the mobile terminal device according to the present invention.

A mobile telephone 41 according to the present embodiment includes a main casing (mobile terminal device main body) 42, a laser projector 43 that is provided separately from the main casing 42, and a screen panel (screen) 44 that is pivotally mounted to the casing of the laser projector 43 so as to be freely openable and closable.

The main casing 42 is provided with all the functions required to serve as a mobile telephone 41; it is capable of originating a call or answering an incoming call in response to the operation of the operation keys 5, playing back received audio, transmitting audio input, and so on.

The laser projector 43 is connected to the main casing 42 by a cord 45 and receives image signals that represent an image such as a guide or the like on the mobile telephone 1 from the main casing 42 to project such an image onto the screen panel 44. The cord 45 is separably connected to either the laser projector 43 or the main casing 42.

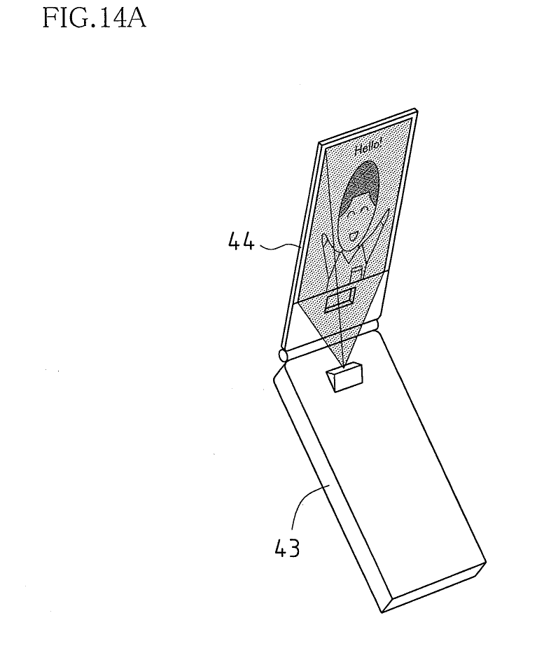

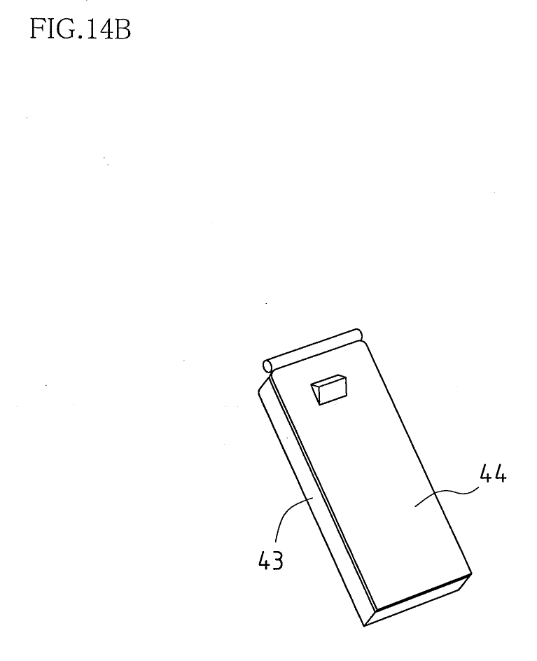

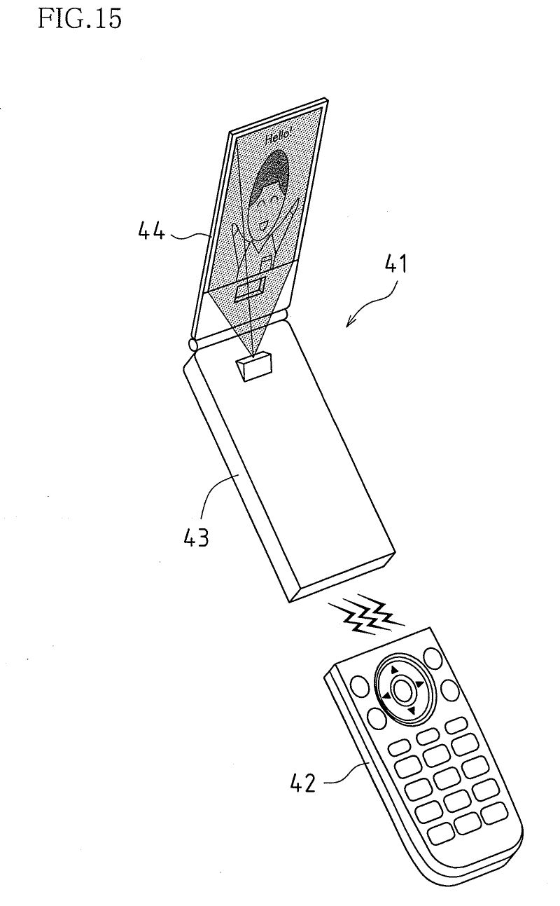

The laser projector 43 also includes a built-in TV tuner or the like that receives and demodulates broadcasting signals broadcast through digital terrestrial broadcasting or the like into image signals; an image that is represented by such image signals is then projected onto the screen panel 44. Thus, it is possible to receive broadcasting signals through digital terrestrial broadcasting or the like and project a received image even if the cord 45 is disconnected as illustrated in FIGS. 14A and 14B and the laser projector 43 is used alone.

Alternatively, as illustrated in FIG. 15, the main casing 42 and the laser projector 43 may be connected through short-range wireless communications.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A mobile terminal device comprising
a mobile terminal device main body;
a laser projector that projects a two-dimensional image by performing two-dimensional scanning of laser light emitted from a semiconductor laser; and
a screen that serves as a main display screen that displays the two-dimensional image projected by the laser projector.

2. The mobile terminal device according to claim 1, wherein the laser projector includes semiconductor lasers that emit respective laser light of a plurality of different wavelengths and projects a two-dimensional color image by performing two-dimensional scanning of the laser light emitted from the semiconductor lasers.

3. The mobile terminal device according to claim 1, wherein a portion near one end of the screen is pivotally mounted to the mobile terminal device main body so that the screen is folded closed by pivoting the screen to overlie the mobile terminal device main body and is opened by pivoting the screen in the reverse direction.

4. The mobile terminal device according to claim 3, wherein the screen is provided with an opening so that when the screen is folded, a laser light outgoing portion of the laser projector is exposed through the opening in the screen.

5. The mobile terminal device according to claim 1, wherein the laser projector is rotatably supported by the mobile terminal device main body, and a laser light outgoing portion of the laser projector is exposed by rotating the laser projector.

6. The mobile terminal device according to claim 1, further comprising a cover that opens/closes a laser light outgoing portion of the laser projector.

7. The mobile terminal device according to claim 1, wherein the screen is provided with a photodetector that detects the laser light emitted from the laser projector.

8. The mobile terminal device according to claim 7, wherein the photodetector includes a plurality of photodetectors provided in the screen.

9. The mobile terminal device according to claim 7, wherein each photodetector is provided at one of the four corners of the screen.

10. The mobile terminal device according to claim 7, further comprising a determination means that determines, based on the timing of laser light detection by the photodetector, the state of the laser light projection on the screen from the laser projector.

11. The mobile terminal device according to claim 1, further comprising an image receiving means that receives an image signal through wired or wireless communications,
wherein the laser projector projects, on the screen, an image that is represented by the image signal received by the image receiving means.

12. The mobile terminal device according to claim 1, further comprising a telephone communications means that makes a telephone call through wired or wireless communications.
